(19) United States
(12) Patent Application Publication
(10) Pub. No.: US 2026/0299465 A1
(43) Pub. Date: Oct. 1, 2026

(54) POWDER TRANSPORTATION DEVICE AND IMAGE FORMING APPARATUS

(71) Applicant: FUJIFILM Business Innovation Corp., Tokyo (JP)

(72) Inventors: Yasuki TANAKA, Kanagawa (JP); Shinichi KURAMOTO, Kanagawa (JP); Kazushi FUJITA, Kanagawa (JP)

(73) Assignee: FUJIFILM Business Innovation Corp., Tokyo (JP)

(21) Appl. No.: 19/262,059

(22) Filed: Jul. 7, 2025

(30) Foreign Application Priority Data
Mar. 26, 2025 (JP) 2025-052250

(51) Int. Cl. G03G 15/08

(52) U.S. Cl. CPC G03G 15/0891; G03G 15/0889; G03G 2215/0819; G03G 2215/0827

(57) ABSTRACT

A powder transportation device includes a first accommodation portion that accommodates powder, a first transportation member that rotates in the first accommodation portion to transport the powder accommodated in the first accommodation portion to a downstream side in a first transportation direction, a second accommodation portion that includes a reception port through which the powder transported to the downstream side in the first transportation direction by the first transportation member is received, and a second transportation member that rotates in the second accommodation portion to transport the powder received through the reception port to a downstream side in a second transportation direction, in which, in a case where a cross section of the second accommodation portion at the reception port is divided into an upper side and a lower side with respect to a position of a rotation axis of the second transportation member, a direction in which the second transportation member rotates on the lower side of the cross section is a direction away from the first accommodation portion, and an inner wall of the second accommodation portion that is positioned on a side opposite to the first accommodation portion on the upper side of the cross section includes an extending portion extending to a side away from the first accommodation portion.

### CROSS-REFERENCE TO RELATED APPLICATIONS

This application is based on and claims priority under 35 USC 119 from Japanese Patent Application No. 2025-052250 filed Mar. 26, 2025.

### BACKGROUND

### (i) Technical Field

The present invention relates to a powder transportation device and an image forming apparatus.

### (ii) Related Art

For example, disclosed in JP1999-24383A is a developing device including a housing that includes a first transportation path for supply of a developer, a second transportation path that is adjacent to the first transportation path and that is disposed to be separated from the first transportation path by a partition wall, and a communication path that communicates with the second transportation path on a downstream side in a transportation direction of the developer in the first transportation path. The developing device includes a first transportation member that is disposed in the first transportation path and that includes a first rotary shaft rotating around an axis and a first spiral blade protruding from an outer peripheral surface of the first rotary shaft. In addition, the developing device includes a second transportation member that is disposed in the second transportation path and that includes a second rotary shaft rotating around an axis and a second spiral blade protruding from an outer peripheral surface of the second rotary shaft. In addition, the developing device includes a blade member that is provided at a position at which the blade member faces the communication path, that protrudes from the outer peripheral surface of the first rotary shaft, and that releases the developer to the second transportation path from a position above the first rotary shaft in the first transportation path as the first rotary shaft rotates.

### SUMMARY

Here, a powder transportation device including a first transportation member that rotates in a first accommodation portion and that transports powder to a downstream side in a first transportation direction and a second transportation member that rotates in a second accommodation portion and that transports, to a downstream side in a second transportation direction, the powder from the first accommodation portion which is received at a reception port will be considered. In a case where a configuration in which the powder is less likely to become stagnant at the reception port of the second accommodation portion is adopted, the amount of powder transported in the first accommodation portion and the second accommodation portion can be increased.

Aspects of non-limiting embodiments of the present disclosure relate to a powder transportation device and an image forming apparatus that increase the amount of transported powder in comparison with a case where a configuration in which the powder is less likely to become stagnant at a reception port of a second accommodation portion is not adopted.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a powder transportation device including a first accommodation portion that accommodates powder, a first transportation member that rotates in the first accommodation portion to transport the powder accommodated in the first accommodation portion to a downstream side in a first transportation direction, a second accommodation portion that includes a reception port through which the powder transported to the downstream side in the first transportation direction by the first transportation member is received, and a second transportation member that rotates in the second accommodation portion to transport the powder received through the reception port to a downstream side in a second transportation direction, in which, in a case where a cross section of the second accommodation portion at the reception port is divided into an upper side and a lower side with respect to a position of a rotation axis of the second transportation member, a direction in which the second transportation member rotates on the lower side of the cross section is a direction away from the first accommodation portion, and an inner wall of the second accommodation portion that is positioned on a side opposite to the first accommodation portion on the upper side of the cross section includes an extending portion extending to a side away from the first accommodation portion.

### BRIEF DESCRIPTION OF THE DRAWINGS

Exemplary embodiment(s) of the present invention will be described in detail based on the following figures, wherein:

FIG. 1 is a view showing an overall configuration of an image forming apparatus;

FIG. 2 is a view showing a developing device;

FIG. 3 is a plan view showing a transportation member of the developing device;

FIG. 4 is a schematic view for description of a developer transportation device according to a first exemplary embodiment;

FIG. 5 is a schematic view for description of a developer transportation device according to a second exemplary embodiment;

FIGS. 6A and 6B are views for description of a developer transportation device according to a third exemplary embodiment, where FIG. 6A is a schematic view of the developer transportation device and FIG. 6B is a view for description of an angle;

FIG. 7 is a schematic view for description of a developer transportation device according to a fourth exemplary embodiment;

FIG. 8 is a schematic view for description of a developer transportation device according to a fifth exemplary embodiment;

FIG. 9 is a schematic view for description of a developer transportation device according to a sixth exemplary embodiment;

FIGS. 10A and 10B are views for description of a developer transportation device according to a seventh exemplary embodiment, where FIG. 10A is a schematic view of the developer transportation device and FIG. 10B is a schematic view for description of a comparative example;

FIG. 11 is a schematic view showing a developer transportation device according to a first application example;

FIG. 12 is a schematic view showing a developer transportation device according to a second application example; and

FIG. 13 is a schematic view showing a developer transportation device according to a third application example.

### DETAILED DESCRIPTION

Hereinafter, exemplary embodiments of the present invention will be described in detail with reference to the accompanying drawings.

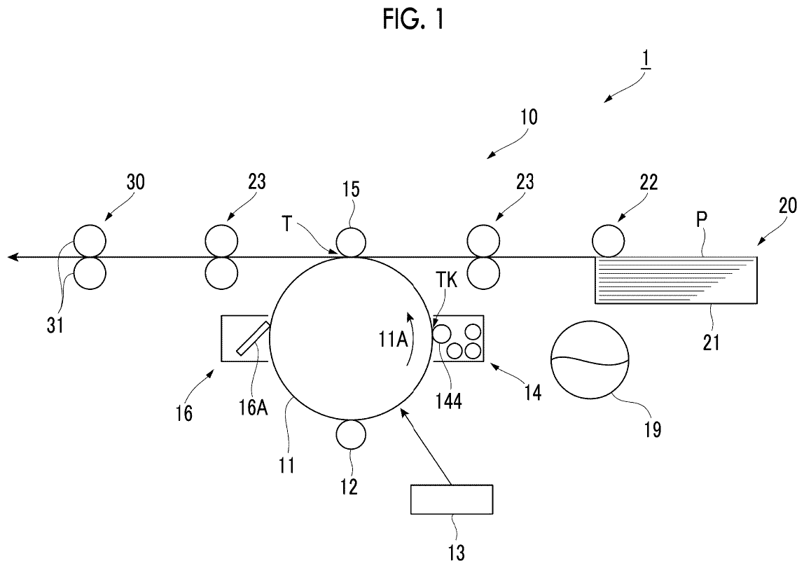

FIG. 1 is a view showing an overall configuration of an image forming apparatus 1. In addition, FIG. 1 is a view showing the image forming apparatus 1 as seen from a front side of the image forming apparatus 1.

The image forming apparatus 1 is provided with an image forming unit 10, a paper sheet supply unit 20, and a fixing unit 30.

The image forming unit 10 forms a toner image on a paper sheet P, which is an example of a recording material, by using an electrophotographic method. The paper sheet supply unit 20 supplies the paper sheet P to the image forming unit 10. The fixing unit 30 fixes, onto the paper sheet P, the toner image formed on the paper sheet P by the image forming unit 10, that is, an image.

The image forming unit 10 is provided with a photoreceptor drum 11 that rotates in a direction represented by an arrow 11A. In addition, the image forming unit 10 is provided with a charging roll 12, an exposure device 13, a developing device 14, a transfer roll 15, and a cleaning device 16.

The photoreceptor drum 11, which is an example of an image holding body, is composed of a cylindrical body. A photosensitive layer (not shown) is formed on a surface of the cylindrical body.

The charging roll 12 is composed of a conductive rubber roll or the like and charges the photoreceptor drum 11.

The exposure device 13 irradiates, with light from a light source such as a laser light source or a light emitting diode (LED), the photoreceptor drum 11 charged by the charging roll 12 so that an electrostatic latent image is formed on the surface of a photoreceptor drum 11.

The developing device 14, which is an example of a developing unit, develops the electrostatic latent image formed on the photoreceptor drum 11 with toner of a predetermined color by causing the toner to adhere to the surface of the photoreceptor drum 11. Accordingly, in the present exemplary embodiment, a toner image is formed on the surface of the photoreceptor drum 11.

The developing device 14 accommodates a developer. The developer of the present exemplary embodiment is composed of a magnetic carrier and colored toner and is a so-referred to as two-component developer.

Furthermore, in the present exemplary embodiment, a developer accommodation container 19 that accommodates a developer to be supplied to the developing device 14 is provided. In the present exemplary embodiment, a new developer is supplied from the developer accommodation container 19 to the developing device 14 through a developer transportation path (not shown).

The transfer roll 15, which is an example of a transfer unit, is composed of a conductive rubber roll or the like.

In the present exemplary embodiment, a position where the transfer roll 15 and the photoreceptor drum 11 face each other is a transfer portion T. At the transfer portion T, a toner image on the surface of the photoreceptor drum 11 (that is, a toner image held by the photoreceptor drum 11) is transferred to the paper sheet P transported thereto.

The cleaning device 16 is provided with a contact member 16A that is disposed in contact with the photoreceptor drum 11, and the cleaning device 16 removes an adhering substance such as toner on the photoreceptor drum 11.

Note that although a configuration in which the transfer roll 15 transfers a toner image to the paper sheet P is adopted in the present exemplary embodiment, the present invention is not limited thereto and a configuration in which the transfer roll 15 transfers the toner image to an intermediate transfer belt (not shown) may also be adopted.

The paper sheet supply unit 20 is provided with a paper sheet accommodation container 21 that accommodates the paper sheet P and a feeding mechanism 22 that feeds the paper sheet P from the paper sheet accommodation container 21.

Furthermore, in the present exemplary embodiment, a paper sheet transportation mechanism 23 that transports, via the transfer portion T and the fixing unit 30, the paper sheet P fed from the paper sheet supply unit 20 is provided.

The fixing unit 30, which is an example of a fixation unit, is provided with a pair of rotating bodies 31 rotating in a state of being in contact with each other.

A heating source (not shown) is provided in one rotating body 31 of the pair of rotating bodies 31.

At the fixing unit 30, the paper sheet P is pressurized and heated by the two rotating bodies 31 so that a toner image on the paper sheet P is fixed to the paper sheet P.

An image forming operation in the image forming apparatus 1 will be described.

At the image forming unit 10, the photoreceptor drum 11 that rotates in the direction represented by the arrow 11A is charged by the charging roll 12. Next, the exposure device 13 causes the photoreceptor drum 11 to be exposed to light, so that an electrostatic latent image corresponding to image information is formed on the surface of the photoreceptor drum 11.

Thereafter, the developing device 14 performs development so that a toner image corresponding to the electrostatic latent image is formed on the surface of the photoreceptor drum 11.

The toner image formed on the photoreceptor drum 11 moves toward the transfer portion T as the photoreceptor drum 11 rotates. In addition, the paper sheet P fed from the paper sheet supply unit 20 is transported to the transfer portion T by the paper sheet transportation mechanism 23.

Then, at the transfer portion T, the toner image on the photoreceptor drum 11 is transferred to the paper sheet P transported thereto. Thereafter, the paper sheet P to which the toner image has been transferred passes through the fixing unit 30 to be heated and pressurized, so that the toner image is fixed onto the paper sheet P.

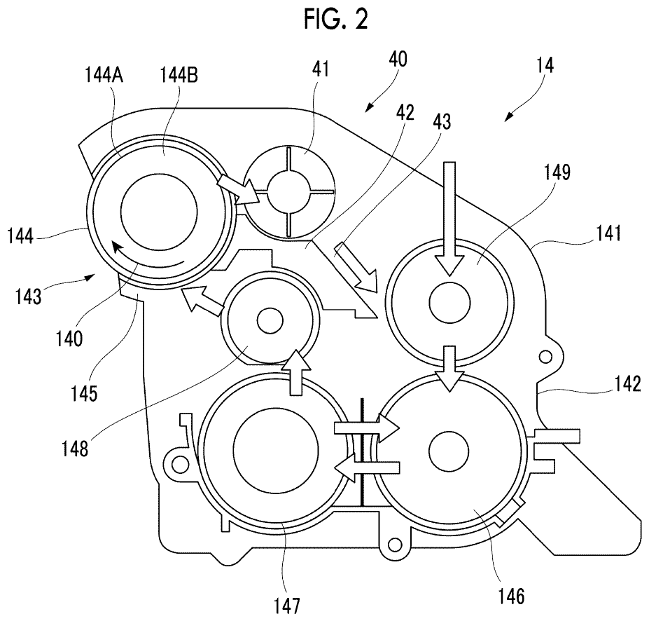

FIG. 2 is a view showing the developing device 14.

The developing device 14 includes an accommodation portion 141 that accommodates a developer (not shown). The accommodation portion 141 is composed of an accommodation housing 142 made of resin.

The accommodation housing 142 of the developing device 14 is disposed to extend along a direction orthogonal to the paper surface of FIG. 2, which is a direction from a front side to a rear side of the image forming apparatus 1 (refer to FIG. 1). The accommodation housing 142 includes a rear-side end portion (not shown) on the rear side and a front-side end portion (not shown) on the front side.

The accommodation housing 142, which is an example of a supply unit, is provided with an opening portion 143 that is provided at a position at which the opening portion 143 faces the photoreceptor drum 11 (refer to FIG. 1). The opening portion 143 is provided with a facing member 144 that causes a developer to adhere to the surface of the photoreceptor drum 11.

The facing member 144, which is an example of a developer holding body, is formed in a columnar shape, and is disposed to extend along a direction from the front side to the rear side of the image forming apparatus 1. Additionally, the facing member 144 is disposed along a longitudinal direction of the developing device 14.

The facing member 144 is provided with a sleeve 144A that is composed of a cylindrical body and that performs a rotationally driving operation and a magnet roll 144B that is disposed inside the sleeve 144A.

The sleeve 144A is formed of metal such as SUS, for example. In addition, the sleeve 144A rotates in a direction along an arrow 140 in the drawing.

Furthermore, in the present exemplary embodiment, the sleeve 144A and the photoreceptor drum 11 rotate such that the sleeve 144A and the photoreceptor drum 11 are moved in the same direction at a facing portion TK (refer to FIG. 1) between the facing member 144 and the photoreceptor drum 11.

The developing device 14 is provided with a layer regulating member 145 that regulates the thickness of a layer of a developer held at the facing member 144.

In addition, as shown in FIG. 2, the developing device 14 is provided with a transportation member 146 and a transportation member 147 that transport a developer.

The transportation member 146 and the transportation member 147, which are examples of a plurality of rotating members, are provided on a side opposite to a side, on which the photoreceptor drum 11 (refer to FIG. 1) is installed, with the facing member 144 interposed therebetween.

The transportation member 146 has a rotation axis extending along a rotation axis of the sleeve 144A that performs a rotationally driving operation and rotates around the rotation axis to transport a developer in the accommodation portion 141.

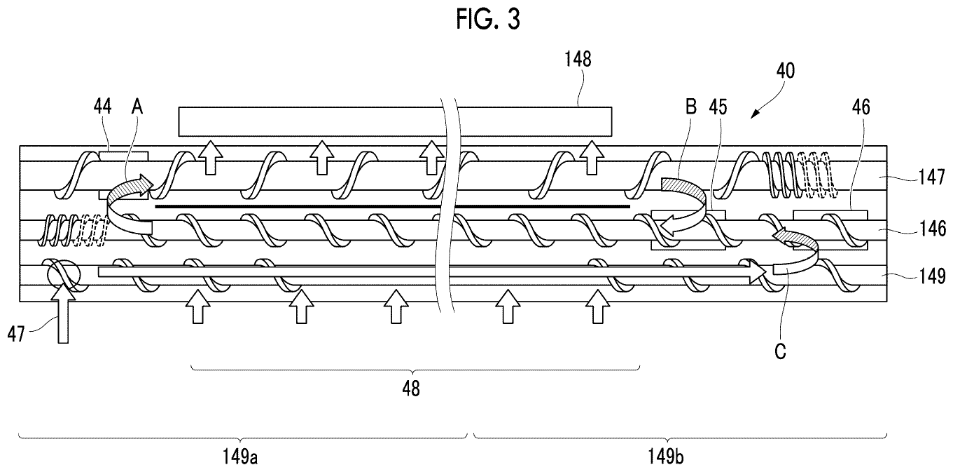

A partition wall represented by a thick straight line is formed between the transportation member 146 and the transportation member 147 (refer to FIG. 2 or FIG. 3).

In the developing device 14 configured as described above, new toner supplied from the developer accommodation container 19 or toner to which a minute amount of carrier is added (hereinafter, referred to as additional toner) is circulated and transported by being agitated and transported between the transportation member 146 and the transportation member 147. More specifically, a developer may be delivered through communication ports formed at both ends of the partition wall extending in an axial direction or opening portions (which will be described later) so that a developer agitated at the transportation member 146 is agitated by the transportation member 147 and is further agitated at the transportation member 146 as well. In the developing device 14, a circulation path, which is a path in which circulation in the axial direction occurs as each of the transportation member 146 and the transportation member 147 rotates, is formed.

In addition, as shown in FIG. 2, the developing device 14 is provided with a transportation member 148 to deliver, to the facing member 144, a developer agitated and transported between the facing member 144 and the transportation member 147.

The developing device 14 is provided with a transportation member 149 that is positioned above the transportation member 146.

A transportation path formed due to rotation of the transportation member 149 is connected to the circulation path. The transportation member 149 receives a collected developer, which is a developer collected from the facing member 144, and an additional toner from the developer accommodation container 19. The transportation member 149 transports the collected developer and the additional toner through the transportation path while agitating the collected developer and the additional toner, and discharges the collected developer and the additional toner to the transportation member 146 of the circulation path.

As described above, in the present exemplary embodiment, the collected developer is agitated and transported by the transportation member 149 in the axial direction together with a new developer. Then, the developers are further agitated and transported by the transportation member 146 and the transportation member 147. Therefore, a long agitation distance or a long agitation time is secured in comparison with a case where the transportation member 149 is not provided.

Note that the facing member 144, the layer regulating member 145, the transportation member 146, the transportation member 147, the transportation member 148, and the transportation member 149 are disposed to be approximately parallel to the photoreceptor drum 11 (refer to FIG. 1).

In addition, as shown in FIG. 2, the developing device 14 includes a collected developer transportation unit 40 that transports a collected developer of the facing member 144 to the transportation member 149. The collected developer transportation unit 40 includes, for example, a paddle member 41, a curved surface 42, and a transportation surface 43.

The paddle member 41 rotates in one direction to move the collected developer as the paddle member 41 receives a driving force between the facing member 144 and the transportation member 149.

The curved surface 42 is a transportation surface for transportation of the collected developer.

Along the transportation surface 43, the collected developer is transported to the transportation member 149 even in a case where there is no driving force received. The transportation surface 43 includes an approximately linear inclined surface of which the inclination causes the collected developer to fall due to the action of the weight of the collected developer.

FIG. 3 is a plan view showing the transportation member 146, the transportation member 147, the transportation member 148, and the transportation member 149 of the developing device 14. The left side of FIG. 3 is the front side of the image forming apparatus 1, and the right side of FIG. 3 is the rear side of the image forming apparatus 1.

As shown in FIG. 3, the circulation path in which agitation and transportation are performed as each of the transportation member 146 and the transportation member 147 rotates is formed (refer to arrows A and B). A developer in the circulation path is transported to the facing member 144 (refer to FIG. 2) via the transportation member 148 from the transportation member 147 side.

In addition, as shown in FIG. 3, a path in which agitation and transportation are performed as each of the transportation member 149 and the transportation member 146 rotates is formed (refer to an arrow C).

More specifically, a first transportation path in which agitation and transportation are performed as the transportation member 146 rotates is formed. An opening portion 44 is formed at an upstream side of the transportation member 147 to correspond to a position on a downstream side of the first transportation path. The first transportation path is connected to a transportation member 147 side of the circulation path via the opening portion 44 (refer to the arrow A). Accordingly, a developer is delivered from the transportation member 146 to the transportation member 147. The opening portion 44 of the transportation member 147 is a reception port through which a developer transported to a downstream side in a transportation direction by the transportation member 146 is received.

In addition, a second transportation path in which agitation and transportation are performed as the transportation member 147 rotates is formed. An opening portion 45 is formed at an upstream side of the transportation member 146 to correspond to a position on a downstream side of the second transportation path. The second transportation path is connected to a transportation member 146 side of the circulation path via the opening portion 45 (refer to the arrow B). Accordingly, a developer is delivered from the transportation member 147 to the transportation member 146. The opening portion 45 of the transportation member 146 is a reception port through which a developer transported to a downstream side in a transportation direction by the transportation member 147 is received.

The above-described circulation path is formed by the first transportation path and the second transportation path.

Furthermore, a third transportation path in which agitation and transportation are performed as the transportation member 149 rotates is formed. An opening portion 46 is formed at an upstream side of the transportation member 146 to correspond to a position on a downstream side of the third transportation path. The third transportation path is connected to the transportation member 146 side via the opening portion 46 (refer to the arrow C). Accordingly, a developer is delivered from the transportation member 149 to the transportation member 146. The opening portion 46 of the transportation member 146 is a reception port through which a developer transported to a downstream side in a transportation direction by the transportation member 149 is received.

Note that although a configuration in which the opening portion 45 is positioned at the upstream side of the transportation member 146 and the opening portion 46 is positioned at a further upstream side of the transportation member 146 is adopted in the present exemplary embodiment as described above, the present invention is not limited thereto. For example, a case where a positional relationship between the opening portion 45 and the opening portion 46 in the transportation direction of the transportation member 146 is reversed is also conceivable.

A collected developer is returned to the transportation member 149, which is closest to an upstream side among the transportation member 147, the transportation member 148, and the transportation member 149.

In addition, to the transportation member 149 closest to the upstream side, a new developer from the developer accommodation container 19 is supplied and the collected developer transported by the collected developer transportation unit 40 is returned.

In a case where the transportation member 149 is divided into an upstream portion 149a and a downstream portion 149b in a rotation axis direction, the new developer is supplied to the position of an arrow 47, that is, the upstream portion 149a.

In addition, the collected developer is carried into the position of a region 48 extending in the transportation direction. That is, the collected developer is carried into the upstream portion 149a and is carried into the downstream portion 149b as well. The region 48 is positioned closer to the upstream portion 149a.

Here, for example, in a case where a developer transported by the transportation member 146 is delivered to the opening portion 44 positioned at the upstream side of the transportation member 147, it may be difficult to receive the developer at the opening portion 44 in a case where there is an increase in number of developers to be transported.

Since such a situation where it is difficult to receive a developer also occurs in the case of reception of a developer at the opening portion 45, it is difficult for a developer to circulate in the circulation path. Furthermore, the same applies to reception of a developer at the opening portion 46 although the opening portion 46 is not in the circulation path.

Therefore, in the present exemplary embodiment, a configuration is adopted in which a developer is smoothly received at the opening portions 44, 45, and 46 and thus the developer is less likely to become stagnant even in the case of an increase in number of developers to be transported.

Hereinafter, a first exemplary embodiment and the like will be described.

### First Exemplary Embodiment

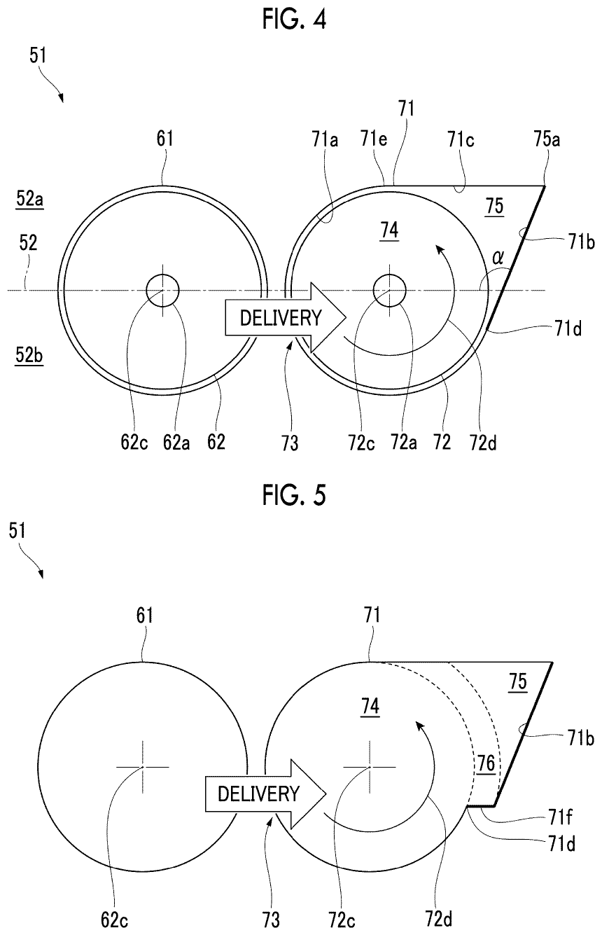

FIG. 4 is a schematic view for description of a developer transportation device 51 according to the first exemplary embodiment.

As shown in FIG. 4, the developer transportation device 51 according to the first exemplary embodiment includes an accommodation portion 61 that accommodates a developer and a transportation member 62 that is held in the accommodation portion 61.

The transportation member 62 includes a rotary shaft portion 62a and a protruding portion (for example, refer to FIG. 4) that protrudes from an outer peripheral surface of the rotary shaft portion 62a and is spirally provided along an axial direction of the rotary shaft portion 62a. The transportation member 62 transports the developer accommodated in the accommodation portion 61 to a downstream side in a transportation direction by means of the above-described protruding portion as the rotary shaft portion 62a rotates. The rotary shaft portion 62a of the transportation member 62 rotates around a rotation center 62c.

In addition, the developer transportation device 51 shown in FIG. 4 includes an accommodation portion 71 that receives the developer that is transported by the transportation member 62 to the downstream side in the transportation direction from the accommodation portion 61, and a transportation member 72 that is held in the accommodation portion 71.

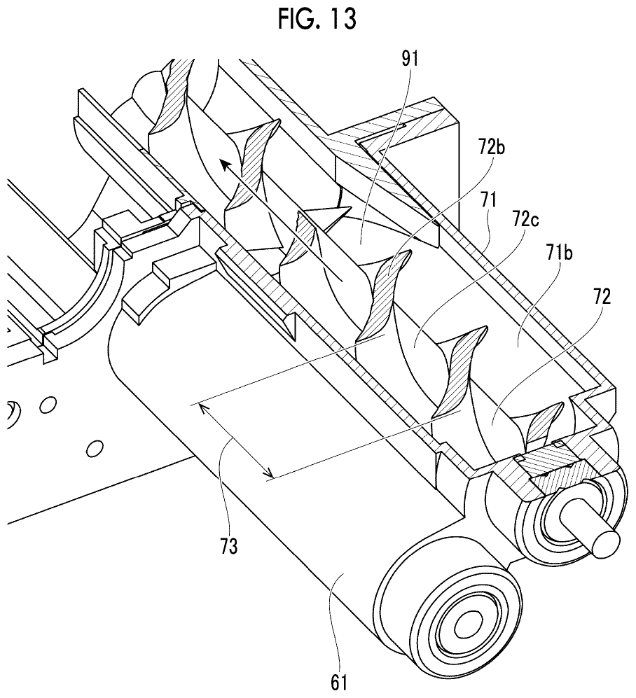

The transportation member 72 includes a rotary shaft portion 72a and a protruding portion 72b (for example, refer to FIG. 13) that protrudes from an outer peripheral surface of the rotary shaft portion 72a and is spirally provided along an axial direction of the rotary shaft portion 72a. The transportation member 72 transports the developer accommodated in the accommodation portion 71 to a downstream side in a transportation direction by means of the above-described protruding portion 72b as the rotary shaft portion 72a rotates. The rotary shaft portion 72a of the transportation member 72 rotates around a rotation center 72c.

Delivery of a developer from the accommodation portion 61 to the accommodation portion 71 is performed through an opening portion 73 provided at the accommodation portion 71.

Here, the accommodation portions 61 and 71 shown in FIG. 4 are a part of the accommodation portion 141 (refer to FIG. 2) of the developing device 14 and are composed of the accommodation housing 142 (refer to FIG. 2).

In addition, in a case where the transportation member 62 shown in FIG. 4 is the transportation member 146 (refer to FIG. 3), the transportation member 72 shown in FIG. 4 is the transportation member 147 (refer to FIG. 3). In addition, in such a case, the opening portion 73 of the accommodation portion 71 shown in FIG. 4 corresponds to the opening portion 44 (refer to FIG. 3).

In addition, in a case where the transportation member 62 shown in FIG. 4 is the transportation member 147 (refer to FIG. 3), the transportation member 72 shown in FIG. 4 is the transportation member 146 (refer to FIG. 3). In addition, in such a case, the opening portion 73 of the accommodation portion 71 shown in FIG. 4 corresponds to the opening portion 45 (refer to FIG. 3).

Furthermore, in a case where the transportation member 62 shown in FIG. 4 is the transportation member 149 (refer to FIG. 3), the transportation member 72 shown in FIG. 4 is the transportation member 146 (refer to FIG. 3). In addition, in such a case, the opening portion 73 of the accommodation portion 71 shown in FIG. 4 corresponds to the opening portion 46 (refer to FIG. 3).

Here, a developer is an example of powder. The developer transportation device 51 is an example of a powder transportation device.

In addition, the accommodation portion 61 is an example of a first accommodation portion, and the accommodation portion 71 is an example of a second accommodation portion. The transportation member 62 is an example of a first transportation member, and the transportation member 72 is an example of a second transportation member.

Furthermore, the opening portion 73 is an example of a reception port of the second accommodation portion.

Furthermore, the rotation center 62c of the rotary shaft portion 62a is an example of a rotation axis of the first transportation member, and the rotation center 72c of the rotary shaft portion 72a is an example of a rotation axis of the second transportation member.

Note that FIG. 4 shows cross sections of the accommodation portions 61 and 71 of the developer transportation device 51 at the opening portion 73 and is an example of a cross section of the second accommodation portion at the reception port.

In a case as shown in FIG. 4, the accommodation portion 61 is positioned on a left side, and the accommodation portion 71 is positioned on a right side. In addition, the transportation member 72 in the accommodation portion 71 rotates in a counterclockwise direction.

Description will be made in more detail. In FIG. 4, a horizontal line 52 represented by a one-dot chain line is a line connecting the rotation center 62c of the transportation member 62 and the rotation center 72c of the transportation member 72 to each other. In a case where division into an upper side 52a and a lower side 52b is performed at the position of the horizontal line 52, a rotation direction 72d in which the transportation member 72 rotates on the lower side 52b with respect to the horizontal line 52 is a direction away from the accommodation portion 61.

The horizontal line 52 is an example of a line extending in a right-left direction in a cross section.

In addition, as shown in FIG. 4, the accommodation portion 71 includes an additional space 75 provided on a side separated from the accommodation portion 61. The additional space 75 referred to herein is a space added to a body space 74, which is a columnar space necessary for rotation of the transportation member 72, and is a space smoothly connected to the columnar space. An internal space of the accommodation portion 71 is formed to include the body space 74 and the additional space 75.

The additional space 75 shown in FIG. 4 is positioned at an upper right portion of the accommodation portion 71. The additional space 75 is positioned on a side opposite to the opening portion 73 described above. That is, in FIG. 4, the additional space 75 is positioned at the upper right portion of the accommodation portion 71 while the opening portion 73 is positioned at a lower left portion of the accommodation portion 71.

An inner wall of the accommodation portion 71 includes an arc-shaped inner wall portion 71a extending along a virtual circle in the case of rotation of the transportation member 72 and inner wall portions 71b and 71c each having a shape other than an arc-like shape. The additional space 75 described above is formed by the inner wall portions 71b and 71c each having a shape other than an arc-like shape. The inner wall portions 71b and 71c extend toward a side away from the accommodation portion 61.

The additional space 75 formed by the inner wall portions 71b and 71c is added to a space formed by the inner wall portion 71a as an internal space of the accommodation portion 71.

As described above, an inner wall of the accommodation portion 71 that is positioned on a side opposite to the accommodation portion 61 on the upper side 52a with respect to the horizontal line 52 includes the inner wall portions 71b and 71c extending to the side away from the accommodation portion 61. In FIG. 4, the additional space 75 includes an acute-angled corner portion 75a provided at a position where the inner wall portion 71b and the inner wall portion 71c intersect with each other.

More specifically, in the first exemplary embodiment, as shown in FIG. 4, the inner wall portion 71b of the accommodation portion 71 is an inclined surface that is inclined at a predetermined angle. In FIG. 4, the inner wall portion 71b linearly extends in an oblique rightward and upward direction.

An angle α of the inner wall portion 71b with respect to the horizontal line 52 is an angle larger than an angle of 90 degrees. In addition, the angle of the inner wall portion 71b with respect to a vertical direction or a gravity direction is an angle (α−90 degrees) smaller than an angle of 90 degrees. As described above, the inner wall portion 71b is inclined toward a side opposite to the accommodation portion 61 side.

More specifically, in FIG. 4, the inner wall portion 71b extends in a direction along a tangent line to one end portion 71d of the arc-shaped inner wall portion 71a. The one end portion 71d of the inner wall portion 71a is an end close to the horizontal line 52. In addition, the one end portion 71d of the inner wall portion 71a is positioned closer to the lower side 52b than the horizontal line 52 is. Therefore, the inner wall portion 71b is positioned on the upper side 52a with respect to the horizontal line 52 and is also positioned on the lower side 52b. That is, the inner wall portion 71b extends upward from the lower side 52b with respect to the horizontal line 52.

Note that an example in which the inner wall portion 71b extends upward from the position of the horizontal line 52 (that is, from a position at the same height as the rotation center 72c) is also conceivable. In addition, an example in which the inner wall portion 71b extends upward from the upper side 52a with respect to the horizontal line 52 is also conceivable.

In a case as shown in FIG. 4, the inner wall portion 71b extends from the lower side 52b with respect to the horizontal line 52. In addition, the predetermined angle in this case is the angle of the direction along the tangent line to the one end portion 71d.

The arc-shaped inner wall portion 71a is an example of an arc-shaped inner wall, and the one end portion 71d is an example of an end close to an extending portion.

The inner wall portion 71c of the accommodation portion 71 is a surface extending in the same direction as a direction in which the horizontal line 52 extends. The inner wall portion 71c extends in a rightward direction in FIG. 4. Note that in FIG. 4, the inner wall portion 71c extends in a direction along a tangent line to the other end portion 71e of the arc-shaped inner wall portion 71a.

Although the inner wall portion 71b is an inclined surface in the first exemplary embodiment shown in FIG. 4, the present invention is not limited thereto and a case where the inner wall portion 71b has a curved shape or an arc-like shape of which the curvature is different from the curvature of an arc of the arc-shaped inner wall portion 71a is also conceivable.

In the first exemplary embodiment, since the above-described configuration is adopted, actions as follows are achieved.

A developer received from the accommodation portion 61 through the opening portion 73 of the accommodation portion 71 starts to be transported in the transportation direction by the transportation member 72 while moving in the rotation direction 72d.

As shown in FIG. 4, the inner wall portion 71b of the accommodation portion 71, which forms the additional space 75, is inclined at an angle equal to or larger than an angle of 90 degrees and the cross-sectional area of the additional space 75 is large.

Therefore, the developer delivered from the accommodation portion 61 to the accommodation portion 71 is transported downstream while a portion thereof is temporarily confined in the additional space 75. Therefore, porosity near the opening portion 73 is increased, so that a transportation flow rate can be increased. In a case where the porosity described herein is low, it is difficult to receive a developer. However, in a case where the porosity is high, the efficiency of reception of a developer is improved.

In addition, in the first exemplary embodiment, the inner wall portion 71b extends linearly. Therefore, in a case where a developer confined in the additional space 75 is transported in the transportation direction, the developer is replaced. In a case where a developer continues to stay in the additional space 75, the characteristics of the developer are deteriorated. In a case where a developer that has continuously stayed in the additional space 75 is transported after being mixed with another developer due to, for example, vibration, the image quality is affected. Therefore, a developer is replaced in the additional space 75 while a portion of the developer is confined in the additional space 75 so that the deterioration of the characteristics of the developer is prevented.

In a case where a configuration in which the inner wall portion 71b extends in the direction along the tangent line to the one end portion 71d of the inner wall portion 71a is adopted, replacement of a developer as described herein is facilitated.

### Second Exemplary Embodiment

FIG. 5 is a schematic view for description of the developer transportation device 51 according to a second exemplary embodiment.

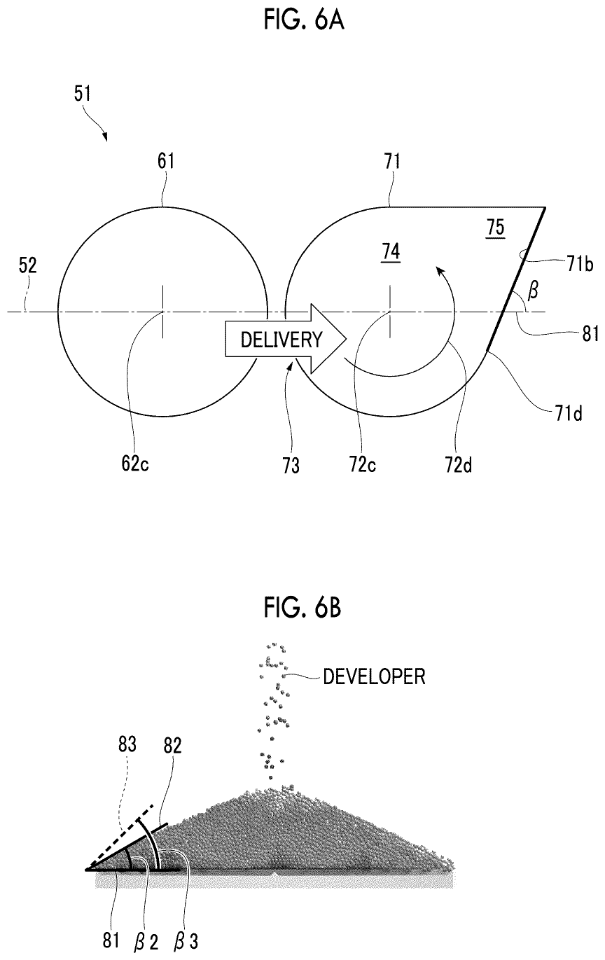

Since the second exemplary embodiment has components common to the first exemplary embodiment described above, description about the common components may be omitted. In addition, the transportation members 62 and 72 in the second exemplary embodiment are the same as the transportation members 62 and 72 in the first exemplary embodiment. Therefore, in FIG. 5, the rotation centers 62c and 72c of the transportation members 62 and 72 and the rotation direction 72d are shown but the other components are not shown. The same applies to FIG. 6 and the subsequent drawings which will be described later.

As shown in FIG. 5, the developer transportation device 51 according to the second exemplary embodiment includes the accommodation portions 61 and 71.

The accommodation portion 71 shown in FIG. 5 includes a connection portion 71f between the one end portion 71d of the inner wall portion 71a and the inner wall portion 71b. The connection portion 71f extends in a direction different from a direction in which the inner wall portion 71b extends. More specifically, the connection portion 71f extends from the inner wall portion 71b and extends in a direction away from the accommodation portion 61. In an example shown in FIG. 5, the connection portion 71f extends in the same direction as the direction in which the horizontal line 52 extends (refer to FIG. 4). An example in which the connection portion 71f extends in a direction different from the direction in which the horizontal line 52 extends, for example, in the vertical direction is also conceivable.

Although the second exemplary embodiment shown in FIG. 5 is the same as the case of the first exemplary embodiment in that the accommodation portion 71 includes the body space 74 and the additional space 75, the second exemplary embodiment is different from the case of the first exemplary embodiment in that a supplementary space 76 added by the connection portion 71f is provided.

In the second exemplary embodiment, since the supplementary space 76 attributable to the connection portion 71f is provided, internal spaces of the accommodation portion 71 other than the body space 74 are the additional space 75 and the supplementary space 76. Therefore, in the case of the second exemplary embodiment, a space in which a developer is confined is larger than in the case of the first exemplary embodiment. Therefore, in the second exemplary embodiment, in comparison with a case of the first exemplary embodiment, the efficiency of reception of a developer can be improved even in a case where a transportation flow rate is further increased.

Note that the inner wall portion 71b extends in the direction along the tangent line to the one end portion 71d, as in the case of the first exemplary embodiment.

The connection portion 71f is an example of a portion of connection.

### Third Exemplary Embodiment

FIGS. 6A and 6B are views for description of the developer transportation device 51 according to a third exemplary embodiment, where FIG. 6A is a schematic view of the developer transportation device 51 and FIG. 6B is a view for description of an angle β.

The inner wall portion 71b of the accommodation portion 71 shown in FIG. 6A is an inclined surface extending linearly as in the case of the first exemplary embodiment (refer to FIG. 4). However, the inner wall portion 71b is inclined with respect to a line segment 81 at the angle β. The line segment 81 is parallel to the horizontal line 52 shown in FIG. 6A.

The angle β shown in FIG. 6A is an angle equal to or larger than an angle of repose unlike the case of the first exemplary embodiment (refer to FIG. 4) in which the angle of the direction along the tangent line to the one end portion 71d is adopted.

The angle of repose mentioned herein is an indicator indicating the fluidity of a developer.

The angle of repose is an angle β2 of a slope at which a pile of developers is stably maintained without spontaneously collapsing, as shown in FIG. 6B. That is, a bottom surface corresponds to the line segment 81, and a line segment 82 is a line intersecting the line segment 81 at the angle β2.

As shown in FIG. 6B, developers below the line segment 82 are stable and do not collapse, but developers stacked above the line segment 82 are made unstable and collapse.

More specifically, as shown in FIG. 6B, in a case where an angle β3 at which a line segment 83 intersects the line segment 81 is steeper than the angle of repose (β3>β2), developers above the line segment 83 are made unstable and collapse. Therefore, in a case where the angle β3 is larger than the angle of repose, accumulation of developers in the additional space 75 can be prevented, and replacement of the developers is facilitated. Accordingly, it is possible to prevent the developers from being immobile in the additional space 75 and to prevent deterioration of the developers.

In the third exemplary embodiment, by using such a characteristic of the angle of repose, the angle β of the inner wall portion 71b is set such that developers are likely to collapse in the additional space 75 of the accommodation portion 71 shown in FIG. 6A.

Note that since the value of the angle of repose differs depends on a developer, the value of the angle β shown in FIG. 6A corresponds to a developer actually used.

### Fourth Exemplary Embodiment

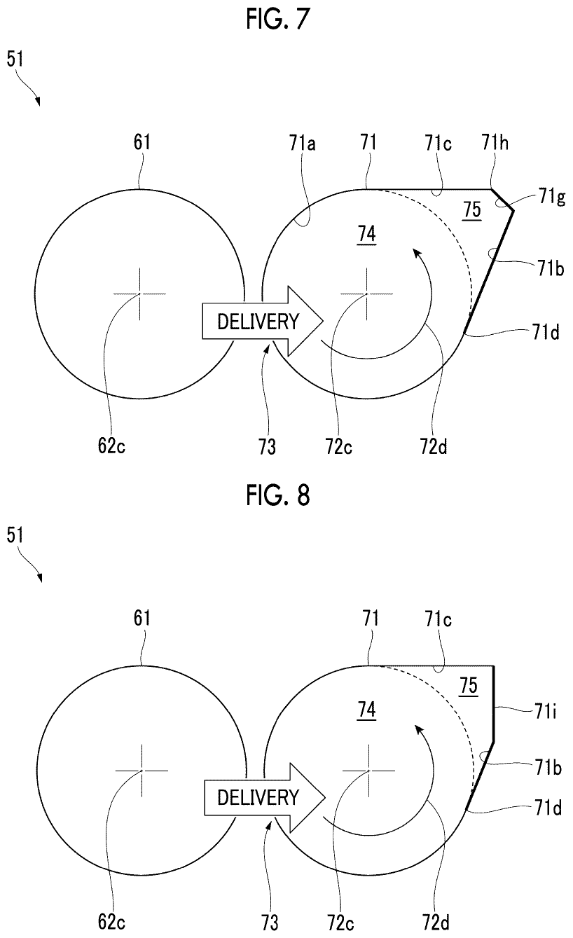

FIG. 7 is a schematic view for description of the developer transportation device 51 according to a fourth exemplary embodiment.

The accommodation portion 71 shown in FIG. 7 includes an inner wall portion 71g between the inner wall portion 71b and the inner wall portion 71c. The inner wall portion 71g is positioned at a position corresponding to the acute-angled corner portion 75a (refer to FIG. 4) in the first exemplary embodiment. The inner wall portion 71g extends in a direction different from a direction in which the inner wall portion 71b extends.

As shown in FIG. 7, the inner wall portion 71g of the accommodation portion 71 in the fourth exemplary embodiment is a portion of connection between an upper end of the inner wall portion 71b and a right end 71h of the inner wall portion 71c.

As shown in FIG. 7, the inner wall portions 71b, 71c, and 71g form a continuous inner wall so that the additional space 75 in the fourth exemplary embodiment is formed.

The inner wall portions 71b and 71c extend in a direction away from the rotation center 72c. The rotation center 72c refers to a rotation center of the transportation member 72 (refer to FIG. 4).

More specifically, as shown in FIG. 7, the inner wall portion 71b extending from the one end portion 71d of the inner wall portion 71a is inclined in a direction away from the rotation center 72c with respect to the vertical direction. Meanwhile, the inner wall portion 71g extends from the right end 71h of the inner wall portion 71c and is inclined in a direction toward the rotation center 72c with respect to the vertical direction. In addition, the inner wall portion 71g may extend to a side close to the accommodation portion 61 from the upper end of the inner wall portion 71b.

In the fourth exemplary embodiment, the accommodation portion 71 includes the inner wall portion 71g. Therefore, in comparison with a case where the inner wall portion 71g is not provided, developers can be prevented becoming stagnant near the right end 71h and deterioration of the developers can be prevented even in a case where a large number of developers enough to constantly fill the right end 71h of the inner wall portion 71c flows in through the opening portion 73.

In the fourth exemplary embodiment, a positional relationship between the one end portion 71d of the inner wall portion 71a and the right end 71h of the inner wall portion 71c with respect to the rotation center 72c will be focused on. The one end portion 71d is closer to the rotation center 72c than the right end 71h is.

The inner wall portion 71g extends to a side close to the accommodation portion 61 and is an example of another portion.

### Fifth Exemplary Embodiment

FIG. 8 is a schematic view for description of the developer transportation device 51 according to a fifth exemplary embodiment.

The accommodation portion 71 shown in FIG. 8 includes an inner wall portion 71i between the inner wall portion 71b and the inner wall portion 71c. The inner wall portion 71i is positioned at a position corresponding to the acute-angled corner portion 75a (refer to FIG. 4) in the first exemplary embodiment. The inner wall portion 71i extends in a direction different from a direction in which the inner wall portion 71b extends.

The inner wall portion 71i according to the fifth exemplary embodiment corresponds to the inner wall portion 71g (refer to FIG. 7) according to the fourth exemplary embodiment described above.

The inner wall portion 71i extends in the vertical direction in FIG. 8. In this regard, the fifth exemplary embodiment is different from the case of the fourth exemplary embodiment (refer to FIG. 7) in which the inclined inner wall portion 71g is provided.

Accordingly, in the fifth exemplary embodiment, in addition to the above-described effects in the case of the fourth exemplary embodiment, apparatus size reduction can be achieved with the developer transportation device 51 reduced in length in the right-left direction in FIG. 8.

The inner wall portion 71i is an example of another portion and is an example of a vertical wall portion.

### Sixth Exemplary Embodiment

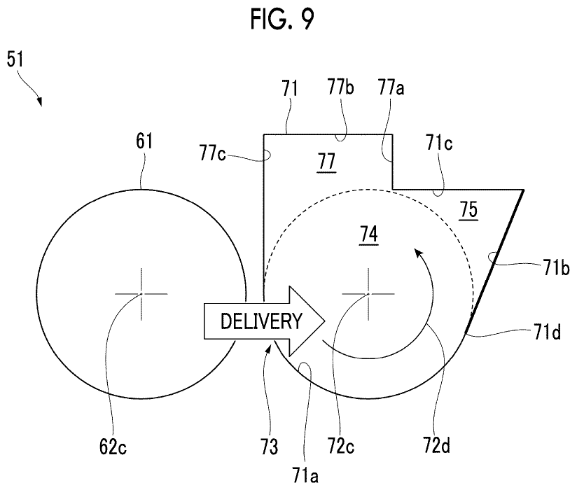

FIG. 9 is a schematic view for description of the developer transportation device 51 according to a sixth exemplary embodiment.

The accommodation portion 71 shown in FIG. 9 includes an upper space 77 in addition to the additional space 75 in the first exemplary embodiment described above.

The upper space 77 mentioned herein is a space that is formed above the body space 74 to be smoothly connected to the body space 74. The internal space of the accommodation portion 71 shown in FIG. 9 is formed to include the body space 74, the additional space 75, and the upper space 77.

Note that the inner wall portion 71c extends in a direction different from a direction in which the inner wall portion 71b extends.

As shown in FIG. 9, the upper space 77 is formed by inner wall portions 77a, 77b, and 77c. The inner wall portion 77a linearly extends upward from a left end of the inner wall portion 71c.

The inner wall portion 77b linearly extends in a leftward direction from an upper end of the inner wall portion 77a. The inner wall portion 77b is formed to be parallel to the inner wall portion 71c.

The inner wall portion 77c linearly extends upward from a left end of the arc-shaped inner wall portion 71a.

More specifically, the position of the inner wall portion 71c of the additional space 75 in a height direction is different from the position of the inner wall portion 77b of the upper space 77 in the height direction. That is, in the sixth exemplary embodiment, the inner wall portion 71c is lower than the inner wall portion 77b. The inner wall portion 71c can be referred to as a ceiling portion of the additional space 75, and the inner wall portion 77b can be referred to as a ceiling portion of the upper space 77. Therefore, the ceiling portion of the additional space 75 is lower than the ceiling portion of the upper space 77. In addition, the ceiling portion of the upper space 77 is higher than the ceiling portion of the additional space 75.

Note that the inner wall portion 77b is closer to the accommodation portion 61 than the inner wall portion 71c is.

The inner wall portion 71c is an example of another portion and is an example of a ceiling portion. In addition, the inner wall portion 77b is an example of another ceiling portion.

In the case of the above-described configuration in the sixth exemplary embodiment, the efficiency of transportation of a developer received through the opening portion 73 to a downstream side in the transportation direction, which is performed by the transportation member 72 (refer to FIG. 4) in the accommodation portion 71, is improved. As a result of the improvement in efficiency of transportation of a received developer, a cavity of the additional space 75 is expanded and the efficiency of reception of the developer is improved, which results in improvement in efficiency of transportation.

The above-described action and effect will be described in more detail.

The transportation member 72 (refer to FIG. 4) is a member that converts rotational energy into transportation energy in the axial direction. However, in a case where a developer is only rotated together with the transportation member 72 (refer to FIG. 4), the developer is not transported in the axial direction. That is, the developer becomes less likely to be rotated together with the transportation member 72 and rotational energy can be converted into transportation energy in a case where upward and downward movement of the developer is suppressed by the inner wall portion 71c of the additional space 75 and the gravity.

In addition, regarding a developer accommodated in the accommodation portion 71, a problem such as hindrance to transportation or the developer blown out from a region at which components are bonded to each other may occur due to air that is contained in the developer and that is transported together with the developer.

In the sixth exemplary embodiment, due to the influence of the rotation direction of the transportation member 72 (refer to FIG. 4), a portion of the inner wall of the accommodation portion 71 that is near the inner wall portion 77b of the upper space 77 is a place that a developer is less likely to enter even in a case where there is an increase in number of transported developers, the accommodation portion 71 surrounding the transportation member 72 (refer to FIG. 4). Therefore, a path from the additional space 75 to the upper space 77 is a path for removal of air in a developer, and thus the above-described problem is suppressed.

### Seventh Exemplary Embodiment

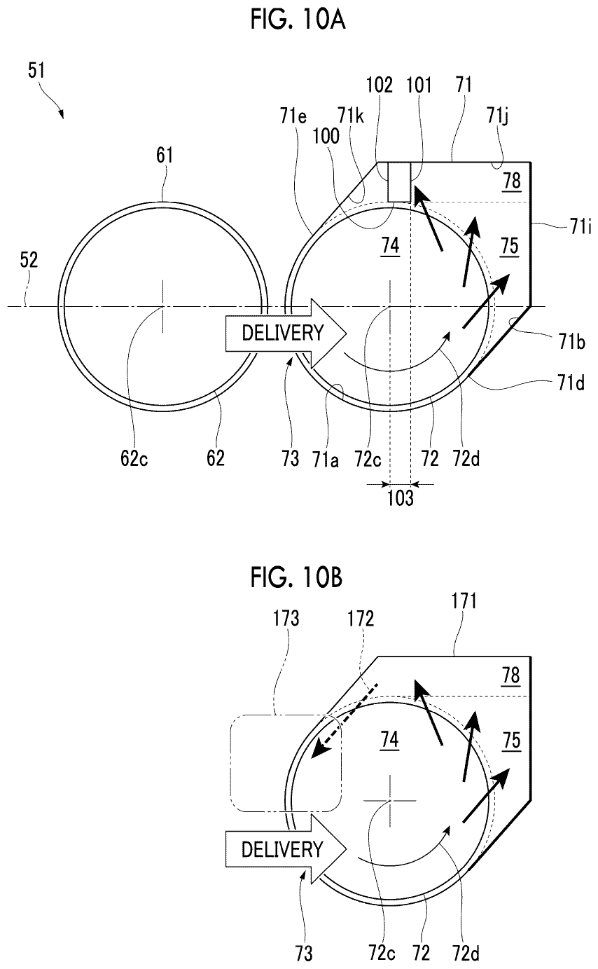

FIGS. 10A and 10B are views for description of the developer transportation device 51 according to a seventh exemplary embodiment, where FIG. 10A is a schematic view of the developer transportation device 51 and FIG. 10B is a schematic view for description of a comparative example. Note that in FIG. 10B, the accommodation portion 61 shown in FIG. 10A is not shown.

The accommodation portion 71 shown in FIGS. 10A and 10B includes an expansion space 78 in addition to the additional space 75 in the first exemplary embodiment described above.

The expansion space 78 mentioned herein is a space that is formed above the body space 74 to be smoothly connected to the body space 74. An internal space of the accommodation portion 71 shown in FIGS. 10A and 10B is formed to include the body space 74 and the expansion space 78.

As shown in FIG. 10A, the expansion space 78 is formed by an upper portion of the inner wall portion 71i, an inner wall portion 71j, and an inner wall portion 71k.

The inner wall portion 71i shown in FIG. 10A is the same as the inner wall portion 71i in the case of the fifth exemplary embodiment described above (refer to FIG. 8). More specifically, in the seventh exemplary embodiment, in a case where the inner wall portion 71i is divided into a lower portion and an upper portion, the lower portion forms a portion of the additional space 75 and the upper portion forms a portion of the expansion space 78.

Here, the inner wall portion 71j shown in FIG. 10A can be referred to as a ceiling portion of the expansion space 78. The inner wall portion 71j is an example of another portion and is an example of a ceiling portion.

As shown in FIG. 10A, the inner wall portion 71j is obtained by shifting the inner wall portion 71c in the above-described fifth exemplary embodiment (refer to FIG. 8) in a direction away from the rotation center 72c. In another viewpoint, the inner wall portion 71j is obtained by extending the inner wall portion 77b of the upper space 77 in the above-described sixth exemplary embodiment (refer to FIG. 9) in a rightward direction to intersect a line obtained in a case where the inner wall portion 71b is extended upward.

As shown in FIG. 10A, the inner wall portion 71k linearly extends in the direction along the tangent line to the other end portion 71e of the arc-shaped inner wall portion 71a and intersects the inner wall portion 71j. Since the other end portion 71e shown in FIG. 10A is positioned above the horizontal line 52 represented by a one-dot chain line, the inner wall portion 71k extends in an oblique rightward and upward direction from the other end portion 71e. Note that the one end portion 71d of the inner wall portion 71a is connected to a lower end portion of the inclined inner wall portion 71b as in the case of the fifth exemplary embodiment (refer to FIG. 8) described above.

In the seventh exemplary embodiment, the inner wall portion 71j is provided with a plate-shaped member 100. As shown in FIG. 10A, the plate-shaped member 100 has a shape extending in the vertical direction, and an upper end of the plate-shaped member 100 is connected to the inner wall portion 71j. In addition, a lower end of the plate-shaped member 100 faces the transportation member 72.

The plate-shaped member 100 is positioned in the expansion space 78, and divides the expansion space 78 into a space on an inner wall portion 71j side and a space on an inner wall portion 71k side. An example in which a lower end-side portion of the plate-shaped member 100 is positioned in the additional space 75 is also conceivable.

More specifically, the plate-shaped member 100 shown in FIG. 10A, includes two side surfaces 101 and 102 that extend in the vertical direction and that connect the upper end and the lower end to each other. The side surface 101, which is one the two side surfaces 101 and 102 and which is far from the transportation member 62, is positioned at a position farther from the transportation member 62 than the rotation center 72c of the transportation member 72 is. That is, the plate-shaped member 100 includes the side surface 101 that is positioned farther from the transportation member 62 than the rotation center 72c of the transportation member 72 is.

Note that the side surface 102 of the plate-shaped member 100 may be positioned at a position farther from the transportation member 62 than the rotation center 72c of the transportation member 72 is, or may be positioned at a position closer to the transportation member 62 than the rotation center 72c is. In addition, the side surface 102 of the plate-shaped member 100 may be at the same position as the rotation center 72c in the direction in which the horizontal line 52 extends.

Regarding the direction in which the horizontal line 52 extends, a distance between the side surface 101 of the plate-shaped member 100 and the rotation center 72c is a distance 103.

In the seventh exemplary embodiment, since the above-described configuration is provided, developers delivered from the accommodation portion 61 may be scattered and separated from the transportation member 72 due to rotation of the transportation member 72 in a case where the developer are transported and may enter the additional space 75 and the expansion space 78. It can be deduced that the scattered developers enter the additional space 75 and the expansion space 78 in directions along solid line arrows shown in FIG. 10A, for example.

Here, how the developers described above behave in a case where the plate-shaped member 100 is not provided as in the comparative example shown in FIG. 10B will be considered. Note that FIG. 10B is different from the configuration of FIG. 10A in that the plate-shaped member 100 is not provided but is the same as the configuration of FIG. 10A in other respects. In addition, solid line arrows in FIG. 10B represent examples of transportation directions of developers as with the solid line arrows in FIG. 10A.

In an accommodation portion 171 in the comparative example shown in FIG. 10B, scattered developers among developers delivered from the accommodation portion 61 enters the body space 74 or enters the expansion space 78 as represented by the solid line arrows. In addition, it can be deduced that the developers scattered in the expansion space 78 advance in a direction along an arrow 172 represented by a broken line due to, for example, the action of an air stream caused by the transportation member 72. In a case where the scattered developers move in the direction along the arrow 172, the scattered developers may enter a region 173 represented by a two-dot chain line and may be mixed with a developer delivered from the accommodation portion 61. In a case where such a situation occurs, a decrease in efficiency of reception is caused.

With regard to this, in the seventh exemplary embodiment, unlike the comparative example, the plate-shaped member 100 is provided in the expansion space 78 as shown in FIG. 10A. Therefore, in the seventh exemplary embodiment, occurrence of a situation in which a developer advances in the direction along the arrow 172 shown in FIG. 10B and enters the region 173 is suppressed, and the efficiency of reception can be improved.

Next, application examples in the above-described first exemplary embodiment (refer to FIG. 4), the above-described second exemplary embodiment (refer to FIG. 5), the above-described third exemplary embodiment (refer to FIG. 6), the fourth exemplary embodiment (refer to FIG. 7), the above-described fifth exemplary embodiment (refer to FIG. 8), the above-described sixth exemplary embodiment (refer to FIG. 9), or the above-described seventh exemplary embodiment (refer to FIG. 10) will be described. In addition, an example in which two or more of a first application example, a second application example, and a third application example which will be described later as the application examples are combined with each other is also conceivable.

### First Application Example

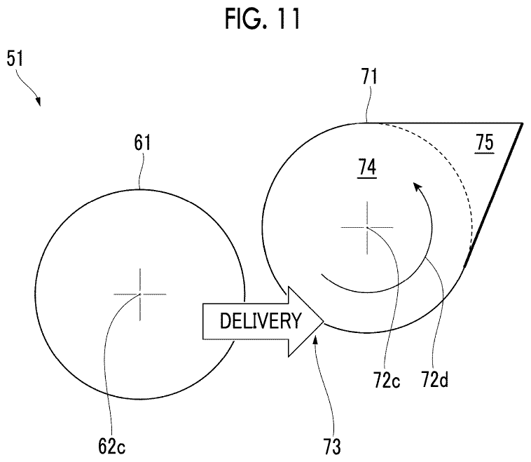

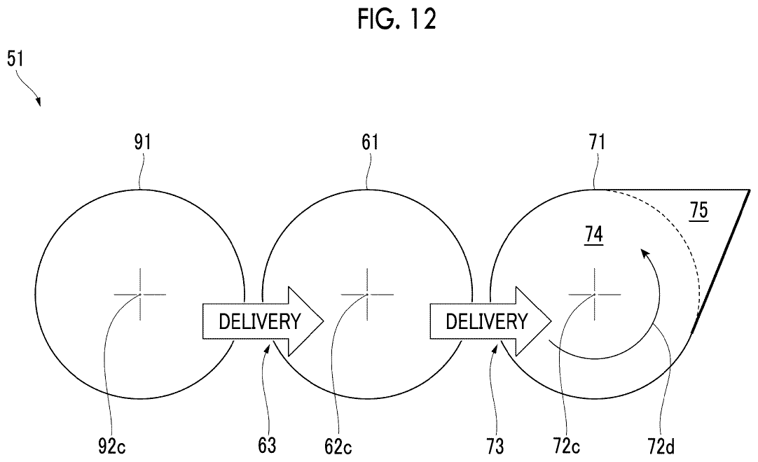

FIG. 11 is a schematic view showing the developer transportation device 51 according to the first application example.

In the first application example shown in FIG. 11, the height of the accommodation portion 61 is different from the height of the accommodation portion 71.

That is, the accommodation portion 71 is installed at a position higher than the accommodation portion 61. According to the first application example, the efficiency of transportation in a case where a developer is transported upward in the vertical direction can be improved.

Note that in the first application example shown in FIG. 11, the configuration of the accommodation portion 71 in the first exemplary embodiment is used as an example. However, the same configuration can be applied to the accommodation portion 71 in other exemplary embodiments. The same applies to other application examples which will be described later.

### Second Application Example

FIG. 12 is a schematic view showing the developer transportation device 51 according to the second application example.

In the second application example shown in FIG. 12, an accommodation portion 91 is provided upstream of the accommodation portion 61. In FIG. 12, the accommodation portion 61 includes an opening portion 63 through which a developer is received from the accommodation portion 91. Accordingly, in the developer transportation device 51 according to the second application example, a developer is transported in the order of the accommodation portions 91, 61, and 71.

The accommodation portion 91 has a rotation center 92c. Applying the same configuration as the accommodation portion 61 to the accommodation portion 91 is conceivable and applying another configuration to the accommodation portion 91 is also conceivable.

According to the second application example, the degree of freedom of the layout of the developer transportation device 51 can be increased.

More specifically, in the second application example, the accommodation portions 91, 61, and 71 are arranged in series regarding delivery of a developer. However, the present invention is not limited thereto, and the accommodation portions 91, 61, and 71 may be arranged in parallel. For example, an example in which a developer is delivered from the accommodation portion 61 to the accommodation portion 91 and the accommodation portion 71 is also conceivable.

In addition, the accommodation portion 61 may be configured to not include the transportation member 62 (refer to FIG. 4) and to be specialized for delivery to the accommodation portions 91 and 71.

In addition, adopting a configuration in which a developer is received from another accommodation portion (not shown) at a position that at least partially overlaps with the axial positions of delivery between the accommodation portions 61, 71, and 91 is also conceivable.

### Third Application Example

FIG. 13 is a schematic view showing the developer transportation device 51 according to the third application example. FIG. 13 is a view showing the accommodation portion 61 together with the accommodation portion 71 of the developer transportation device 51 in a state where the opening portion 73 side of the accommodation portion 71 is broken. Note that an arrow in the drawing represents a direction in which a developer is transported by the transportation member 72.

In the third application example shown in FIG. 13, the inner wall portion 71b is provided in the accommodation portion 71 at the position of the opening portion 73. More specifically, in the third application example, the inner wall portion 71b is not provided over the entire region in a transportation direction represented by the arrow in the drawing. That is, the inner wall portion 71b includes a portion 91 of which the length decreases away from the opening portion 73 in the transportation direction represented by the arrow in FIG. 13. The transportation direction represented by the arrow in FIG. 13 is, any one of directions perpendicular to the paper surface in the case of, for example, FIG. 4 and the length of the inner wall portion 71b shown in FIG. 4 changes toward any one of sides in a direction perpendicular to the paper surface. As described above, the shape the inner wall portion 71b in the third application example differs depending on a position in the transportation direction.

Accordingly, in the third application example, an increase in size of the accommodation portion 71 may be suppressed.

A direction in which the rotation center 72c of the transportation member 72 extends in FIG. 13 is an example of a direction along the rotation axis of the second transportation member. The transportation direction represented by the arrow in the drawing is one direction in the direction in which the rotation center 72c of the transportation member 72 extends.

Although the exemplary embodiments of the present invention have been described above, the technical scope of the exemplary embodiments of the present invention is not limited to the above exemplary embodiments. In addition, various modifications and alternative configurations are involved in the present invention without departing from the technical scope of the present invention.

### Supplementary Note

(((1)))

A powder transportation device comprising:
a first accommodation portion that accommodates powder;
a first transportation member that rotates in the first accommodation portion to transport the powder accommodated in the first accommodation portion to a downstream side in a first transportation direction;
a second accommodation portion that includes a reception port through which the powder transported to the downstream side in the first transportation direction by the first transportation member is received; and
a second transportation member that rotates in the second accommodation portion to transport the powder received through the reception port to a downstream side in a second transportation direction,
wherein, in a case where a cross section of the second accommodation portion at the reception port is divided into an upper side and a lower side with respect to a position of a rotation axis of the second transportation member,
a direction in which the second transportation member rotates on the lower side of the cross section is a direction away from the first accommodation portion, and
an inner wall of the second accommodation portion that is positioned on a side opposite to the first accommodation portion on the upper side of the cross section includes an extending portion extending to a side away from the first accommodation portion.
(((2)))

The powder transportation device according to (((1))),
wherein the extending portion of the inner wall is an inclined surface that is inclined at a predetermined angle.
(((3)))

The powder transportation device according to (((2))),
wherein the predetermined angle is an angle with respect to a line extending in a right-left direction in the cross section, and
the angle is larger than an angle of repose in a case of the powder to be accommodated in the first accommodation portion and the second accommodation portion.
(((4)))

The powder transportation device according to (((2))),
wherein the predetermined angle is an angle of a direction along a tangent line to an end of an arc-shaped inner wall in the cross section that is close to the extending portion.
(((5)))

The powder transportation device according to (((4))),
wherein the inner wall includes a portion of connection between the end close to the extending portion and the extending portion.
(((6)))

The powder transportation device according to (((1))),
wherein the inner wall on the upper side of the cross section includes another portion on the upper side of the cross section, which is connected to an upper end of the extending portion and which extends in a direction different from a direction in which the extending portion extends.
(((7)))

The powder transportation device according to (((6))),
wherein the other portion extends to a side close to the first accommodation portion.
(((8)))

The powder transportation device according to (((6))),
wherein the other portion is a vertical wall portion that extends in a vertical direction in the cross section.
(((9)))

The powder transportation device according to (((6))),
wherein the other portion is a ceiling portion that extends in a right-left direction in the cross section.
(((10)))

The powder transportation device according to (((9))),
wherein the second accommodation portion includes another ceiling portion that is closer to the rotation axis of the second transportation member than the ceiling portion is, and
the other ceiling portion is higher than the ceiling portion.
(((11)))

The powder transportation device according to (((9))),
wherein a plate-shaped member that extends from the ceiling portion in a direction toward the rotation axis of the second transportation member is provided, and
the plate-shaped member includes a surface that is positioned farther from the first transportation member than the rotation axis of the second transportation member is.
(((12)))

The powder transportation device according to any one of (((1))) to (((11))),
wherein a height of a rotation axis of the first transportation member is different from a height of the rotation axis of the second transportation member, and
the rotation axis of the second transportation member is positioned higher than the rotation axis of the first transportation member.
(((13)))

The powder transportation device according to any one of (((1))) to (((12))),
wherein a length of the extending portion of the inner wall decreases away from the reception port in a direction along the rotation axis of the second transportation member.
(((14)))

An image forming apparatus comprising:
an image holding body that holds a latent image;
a developing device that develops the latent image of the image holding body by using a developer containing toner at least; and
the powder transportation device according to any one of (((1))) to (((13))) that supplies the developer to the developing device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A powder transportation device comprising:
a first accommodation portion that accommodates powder;
a first transportation member that rotates in the first accommodation portion to transport the powder accommodated in the first accommodation portion to a downstream side in a first transportation direction;
a second accommodation portion that includes a reception port through which the powder transported to the downstream side in the first transportation direction by the first transportation member is received; and
a second transportation member that rotates in the second accommodation portion to transport the powder received through the reception port to a downstream side in a second transportation direction,
wherein, in a case where a cross section of the second accommodation portion at the reception port is divided into an upper side and a lower side with respect to a position of a rotation axis of the second transportation member,
a direction in which the second transportation member rotates on the lower side of the cross section is a direction away from the first accommodation portion, and
an inner wall of the second accommodation portion that is positioned on a side opposite to the first accommodation portion on the upper side of the cross section includes an extending portion extending to a side away from the first accommodation portion.

2. The powder transportation device according to claim 1,
wherein the extending portion of the inner wall is an inclined surface that is inclined at a predetermined angle.

3. The powder transportation device according to claim 2,
wherein the predetermined angle is an angle with respect to a line extending in a right-left direction in the cross section, and
the angle is larger than an angle of repose in a case of the powder to be accommodated in the first accommodation portion and the second accommodation portion.

4. The powder transportation device according to claim 2,
wherein the predetermined angle is an angle of a direction along a tangent line to an end of an arc-shaped inner wall in the cross section that is close to the extending portion.

5. The powder transportation device according to claim 4,
wherein the inner wall includes a portion of connection between the end close to the extending portion and the extending portion.

6. The powder transportation device according to claim 1,
wherein the inner wall on the upper side of the cross section includes another portion on the upper side of the cross section, which is connected to an upper end of the extending portion and which extends in a direction different from a direction in which the extending portion extends.

7. The powder transportation device according to claim 6,
wherein the other portion extends to a side close to the first accommodation portion.

8. The powder transportation device according to claim 6,
wherein the other portion is a vertical wall portion that extends in a vertical direction in the cross section.

9. The powder transportation device according to claim 6,
wherein the other portion is a ceiling portion that extends in a right-left direction in the cross section.

10. The powder transportation device according to claim 9,
wherein the second accommodation portion includes another ceiling portion that is closer to the rotation axis of the second transportation member than the ceiling portion is, and
the other ceiling portion is higher than the ceiling portion.

11. The powder transportation device according to claim 9,
wherein a plate-shaped member that extends from the ceiling portion in a direction toward the rotation axis of the second transportation member is provided, and
the plate-shaped member includes a surface that is positioned farther from the first transportation member than the rotation axis of the second transportation member is.

12. The powder transportation device according to claim 1,
wherein a height of a rotation axis of the first transportation member is different from a height of the rotation axis of the second transportation member, and
the rotation axis of the second transportation member is positioned higher than the rotation axis of the first transportation member.

13. The powder transportation device according to claim 1,
wherein a length of the extending portion of the inner wall decreases away from the reception port in a direction along the rotation axis of the second transportation member.

14. An image forming apparatus comprising:
an image holding body that holds a latent image;
a developing device that develops the latent image of the image holding body by using a developer containing toner at least; and
the powder transportation device according to claim 1 that supplies the developer to the developing device.

15. An image forming apparatus comprising:
an image holding body that holds a latent image;
a developing device that develops the latent image of the image holding body by using a developer containing toner at least; and
the powder transportation device according to claim 2 that supplies the developer to the developing device.

16. An image forming apparatus comprising:
an image holding body that holds a latent image;
a developing device that develops the latent image of the image holding body by using a developer containing toner at least; and
the powder transportation device according to claim 3 that supplies the developer to the developing device.

17. An image forming apparatus comprising:
an image holding body that holds a latent image;
a developing device that develops the latent image of the image holding body by using a developer containing toner at least; and
the powder transportation device according to claim 4 that supplies the developer to the developing device.

18. An image forming apparatus comprising:
an image holding body that holds a latent image;
a developing device that develops the latent image of the image holding body by using a developer containing toner at least; and
the powder transportation device according to claim 5 that supplies the developer to the developing device.

19. An image forming apparatus comprising:
an image holding body that holds a latent image;
a developing device that develops the latent image of the image holding body by using a developer containing toner at least; and
the powder transportation device according to claim 6 that supplies the developer to the developing device.

20. An image forming apparatus comprising:
an image holding body that holds a latent image;
a developing device that develops the latent image of the image holding body by using a developer containing toner at least; and
the powder transportation device according to claim 7 that supplies the developer to the developing device.
